(19) United States
(12) Patent Application Publication
(10) Pub. No.: US 2025/0253515 A1
(43) Pub. Date: Aug. 7, 2025

(54) HYBRID STRUCTURE FOR ULTRA-WIDEBANDTERAHERTZ GENERATION AND RECEPTION WITH SEMICONDUCTOR DEVICES

(71) Applicant: Universidad Carlos III de Madrid, GETAFE (Madrid) (ES)

(72) Inventors: Guillermo CARPINTERO DEL BARRIO, Madrid (ES); Alejandro RIVERA LAVADO, Madrid (ES); Luis Enrique GARCÍA MUÑOZ, Madrid (ES); Muhsin ALI, Madrid (ES)

(21) Appl. No.: 18/856,022

(22) PCT Filed: Apr. 11, 2023
(86) PCT No.: PCT/EP2023/059391

§ 371 Date: Oct. 10, 2024

(30) Foreign Application Priority Data
Apr. 11, 2022 (EP) EP22382348.5A

(51) Int. Cl. H01P 5/08; H01P 3/02; H01P 3/16

(52) U.S. Cl. CPC H01P 5/087; H01P 3/023; H01P 3/16

(57) ABSTRACT

An ultra-wideband hybrid structure (100) for transmitting high-frequency electrical signals, the structure comprising a substrate (110), a high-speed semiconductor substrate (105) connected to the substrate (110) of the ultra-wideband structure (100), a conductive interface (115) established between the substrate (110) and the high-speed semiconductor substrate (105), an ultrahigh speed device defining a first access port (P1) and established on the high-speed semiconductor substrate (105), a dielectric waveguide structure (DRW) defining a second access port (P2), the structure (DRW) established on the substrate (110) and on the high-speed semiconductor substrate (105), the structure (DRW) comprises a tapered end connectable to the first access port (P1) of the ultrahigh speed device, a metal waveguide structure (TSA) providing a low-pass characteristic interconnection, the structure (TSA) established on the substrate (110) and on the high-speed semiconductor substrate (105), wherein the metal waveguide structure (TSA) comprises a metal waveguide pattern defining a tapered coupler connected to the access port (P1) of the high-speed circuit or component.

### FIELD OF THE INVENTION

The present invention refers to a novel structure enabling ultra-wideband radio-frequency signal generation and detection with semiconductor devices with two distinctive features: first, the structure of the semiconductor material is shaped to form a Radio-Frequency (RF) waveguide, and second, the structure results from the hybrid integration of a small die of III-V semiconductor material for the active device generating the RF and part of the emitting antenna, with a larger sized silicon material for the rest of the antenna and other passive RF components.

### BACKGROUND OF THE INVENTION

Terahertz systems operate in the spectrum range covering frequencies frequency band between 0.1 and 10 THz, which lies between the microwave and the optical frequency bands. The different technologies to produce and detect Terahertz signals require components integrated onto a die (an unpackaged, bare chip) which can either be electronic or photonic. Photonic-based systems require optoelectronic converters, where the active component in the system, being the most common ultrafast photodiodes (mainly p-i-n photodiode, PIN-PD, and uni-traveling-carrier photodiode, UTC-PD) and low-temperature-grown photoconductive antenna (LTG-PCA) photomixers, fabricated using III-V semiconductor compound alloys. There is also a wide range of electronic-based components, commonly Gunn diodes, IMPATT diodes and Resonant-Tunneling Diodes (RTD) as well as varactor Schottky diode multipliers, which generate high frequencies as higher order harmonics from a microwave reference source.

The semiconductor material substrate most commonly used to fabricate photonic and electronic devices is Indium Phosphide (InP), a III-V semiconductor compound in which the highest operating frequencies have been achieved, being the preferred substrate for Terahertz systems. However, the main drawbacks of this material are that is very brittle and its high cost.

These characteristics have a high impact on the dimensions of the die chips, especially for Terahertz generation and reception devices, where in addition to the component (with micrometer size range), it is desirable to integrate RF antennas which have larger footprints (with millimeter size range). The substrate dimensions cannot be lower than a minimum size (>0.5×0.2 mm2) so that the devices can be handled in the assembly processes, nor is recommended to be greater than a maximum size (<12 mm×6 mm) due to the fragility of this material. Chips with dimension outside these boundaries are of course possible, at the expense of considerable higher assembly costs and lower yield. These limitations also result in the fact that for systems operating at lower frequency bands of the spectrum (i.e. the microwave range, from 3 GHz to 30 GHz, or the millimeter-wave range, from 30 GHz to 300 GHz), the die chip area is not sufficient to monolithically integrate the antenna on the substrate used for the component.

One current approach to assemble the chip die and the antenna is shown in FIG. 1, representing a 3D model of the assembly (50) comprising an optical fiber aligned to the optical input of an ultrafast photodiode (PD chip), wherein the electrical contact pads of the ultrafast photodiode excite a planar Tapered-Slot Antenna (TSA) through a microwave access port (Excitation Port 1). In particular, FIG. 1 shows a high-speed photodiode device manufactured on InP (ϵr=12.4) and connected to a TSA-type antenna manufactured on a 110RT/Duroid 5880 low permittivity substrate (ϵr=2.2). The size of said antenna prevents its integration on the InP substrate, which is then realized in a suitable RF substrate, turning into extremely critical the electrical interconnection between the ultrafast photodiode and the antenna, especially as the desired operating frequency range extends into the higher frequency bands.

Among the different interconnection technologies that are currently available, the most common in the electronic industry is gold wire bonding. FIG. 2 shows a photograph of an InP integrated ultrafast photodiode chip (200) where its electrical contact pads are connected to the access port of the antenna through gold wire-bonds. However, the gold wire series parasitic inductance, partially mitigated by using two bonding wires per connection, represents a limit to the maximum operating frequency.

An added difficulty in the interconnection between the component die chip and the antenna RF substrate is the difference in permittivity between substrates. The die chip, with higher refractive index, generates reflections at this interface, which are especially harmful for high frequency signals. These reflections mean that part of the signal is returned to the emitting device, thus reducing the efficiency of the transmitter module.

The present invention overcomes the aforementioned limitations and drawbacks.

### SUMMARY OF THE PRESENT INVENTION

The present invention provides a solution to exploit the full bandwidth of an ultrawideband antenna driven by an ultrahigh speed semiconductor device, enabling to combine different substrates, overcoming the current restrictions of the available electrical interconnections which limit the bandwidth for Terahertz and sub-terahertz systems.

Hence, the present invention represents a new structure for ultrahigh speed devices based on a hybrid dielectric-conductor guide that works from DC to at least 300 GHz. The present invention proposes an ultra-wideband hybrid structure optimized for high-frequency electrical signals, which can operate up to 340 GHz, and can be engineered to reach higher frequencies varying the thickness and/or permittivity of the substrates. The ultra-wideband structure allows the coupling of high frequency signals from high-speed circuits or components manufactured on high-speed semiconductor substrates (e.g. Indium Phosphide), the dimensions of which may be restricted due to technological, manufacturing or handling reasons (that is, there are constraints to its dimensions, preventing the integration of large size components i.e. broadband waveguides or antennas such as tapered bifilar metal waveguides). The ultra-wideband structure solves this problem, enabling high performance emission for high-frequency signals. Hence, the ultra-wideband structure according to the present invention allows most of the signals to be coupled to a single mode for all frequencies within the working bandwidth as shown in FIGS. 4A to 4D.

The main aspects of the hybrid structure according to the present invention are:

A dielectric waveguide excited in a single-mode regime that performs the coupling of the signals from/to the component die chip in the high frequency band. This dielectric waveguide structure comprises a high-pass filter characteristic, enabling the electrical interconnection for signals with frequencies above a low cut-off frequency (fCL). The dielectric waveguide comprising a tapered end which faces an access port (P1) of an ultrahigh speed semiconductor device (electronic or optoelectronic) manufactured on a high permittivity substrate (e.g. Indium Phosphide) cleaved into a die chip. For example, the dielectric waveguide structure can be designed to operate over a range starting at a low cut-off frequency (fCL) in the microwave range (i.e. between 3 GHz to 30 GHz) or in the millimeter-wave range (i.e. between 30 GHz to 300 GHz), e.g. at an operating frequency of 60 GHz covering a broad frequency range that extends into the Terahertz wave range (i.e. between 300 to 3000 GHz) and beyond. The dielectric waveguide structure can be established on the substrate (110) and on the high-speed semiconductor substrate, wherein the structure comprises a tapered end facing the first access port of the ultrahigh speed device.

The hybrid structure according to the present invention also comprises a metal waveguide structure with a low-pass filter characteristic which enables to establish a metallic electrical contact with the access port of the ultrahigh speed device that allows the interconnection operating frequency range to start at low frequencies (i.e. preferably starting at DC, 0 Hz). This enables the electrical interconnection of signals from 0 Hz up to a high cut-off frequency (fCH) in the millimeter-wave range. For example, the metal waveguide structure can be designed to operate over a range that starts at 0 Hz and extends up into the millimeter-wave range (i.e. between 30GHz to 300 GHz, e.g. at an operating frequency of 100 GHz). In a preferred embodiment for wideband operation, this metallic waveguide structure operates over a frequency range that starts at low frequency (i.e. starting at DC, from 0 Hz) and extends above the low cut-off frequency of the dielectric waveguide structure (fCH>fCL, e.g. above the 60 GHz of previous example).

The metal waveguide structure the structure can be established on the substrate and on the high-speed semiconductor substrate, wherein the metal waveguide structure comprises a metal waveguide pattern defining a tapered coupler, preferably a Tapered Slot Antenna “TSA”, around the tapered end of the dielectric waveguide structure and connected to the first access port (P1) of the ultrahigh speed device.

The hybrid structure according to the present invention further comprises an electrical connection at low frequency, which can be made through different techniques (e.g. by bonding or conductive epoxy) that permits less restrictive requirements, both in spatial and electrical precision. The hybrid structure allows ultra-wide band interconnections of electrical signals between substrates of the same or different permittivity, in high frequencies, wherein a change of substrate is critical due to the introduction of a discontinuity. High frequency signal reflections are reduced by bridging said discontinuity e.g. with conductive epoxy permitting to couple the signal to the dielectric waveguide structure.

The hybrid structure according to the present invention can further comprise a ultrahigh speed device for which the semiconductor material of the chip die is structured to shape it into an RF waveguide that mitigates surface modes and maximizes the RF power transfer between the a ultrahigh speed device and the metal waveguide structure at its contact pads. Said semiconductor structure is made through an extra process of chemical etching (wet etching) on the substrate of the ultrahigh speed device in a single additional lithography step, during its manufacture.

### BRIEF DESCRIPTION OF THE DRAWINGS

For a better understanding the above explanation and for the sole purpose of providing an example, some non-limiting drawings are included that schematically depict a practical embodiment.

FIGS. 1 and 2 shows a prior art embodiment.

FIGS. 3A to 3D show four different embodiments of hybrid structures according to the present invention.

FIGS. 4A to 4D show the simulated electric field amplitude distribution at 10 GHz (a), 60 GHz (b), 140 GHz (c) and 300 GHz (d), respectively.

FIGS. 5A and 5B show the S parameters obtained from the performed simulations.

FIGS. 6A and 6B show the interconnection of an ultrahigh speed device manufactured on a high permittivity substrate to another substrate with the same or different permittivity having a rectangular shape or having a shape fitted to the metallic pattern.

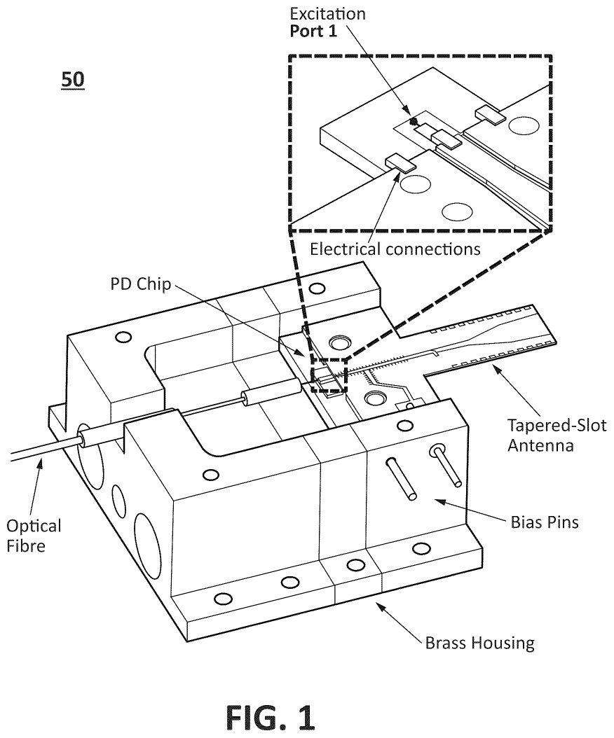

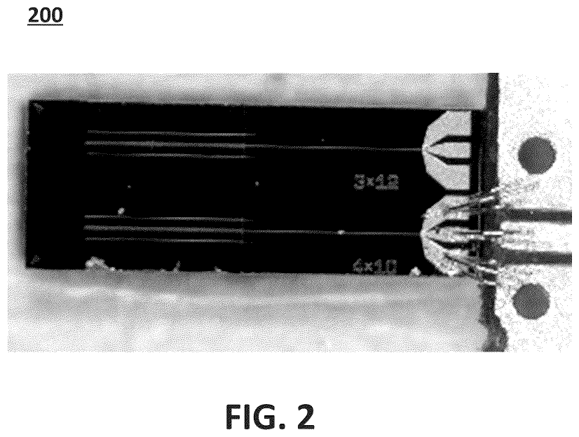

### DETAILED DESCRIPTION OF THE INVENTION

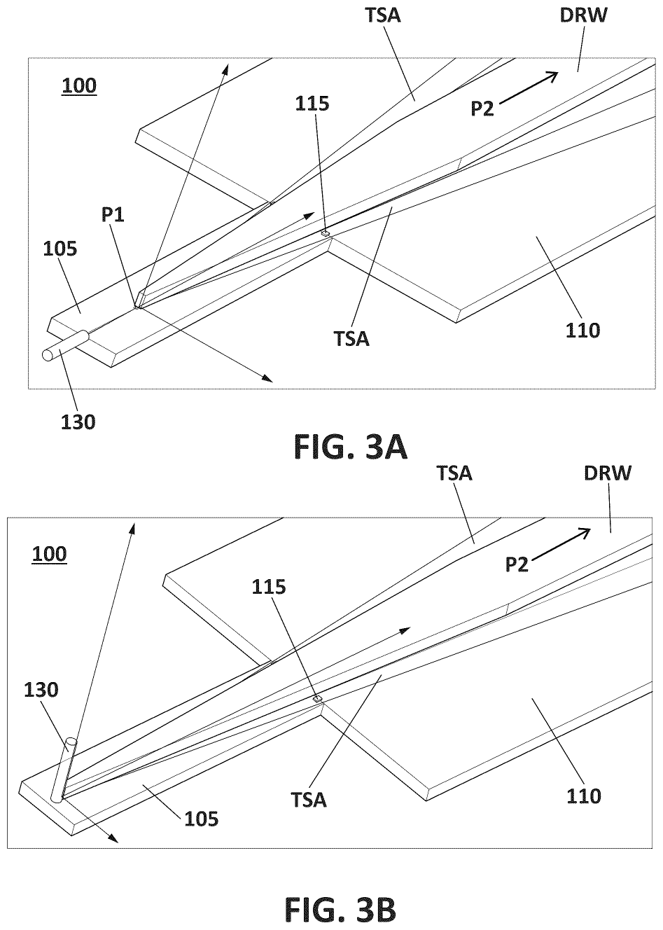

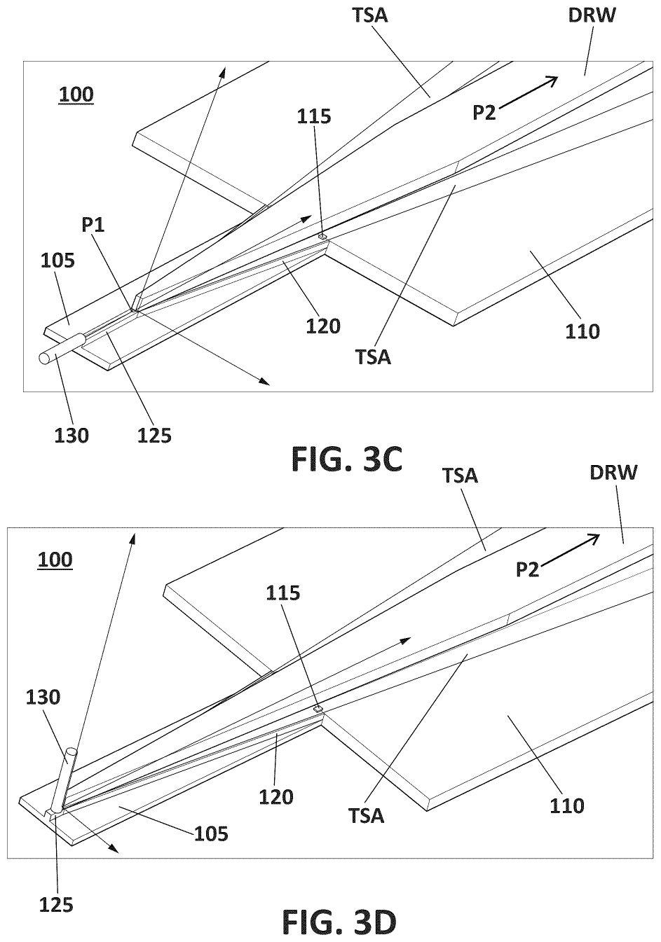

FIG. 3A shows an example of an electrical interconnection according to the present invention, in particular, this figure shows an ultra-wideband hybrid structure (100) for high-frequency electrical signals. The structure (100) comprises an ultrahigh speed device on a high-speed semiconductor substrate (105) (for example, but not limited to, Indium Phosphide “InP”) and a substrate (110), as well as an electrical interconnection (115) established in the splitting point between the substrate (110) and the high-speed semiconductor substrate (105). The splitting point can be selected at a location where the frequency does not cause the hybrid structure (100) to degrade the signal transmission in the electrical interconnection

The high-speed semiconductor substrate (105) contains the ultrahigh speed device for the generation or detection of high frequency signals (i.e. in the range of millimeter and Terahertz waves). The electrical contact pads of this ultrahigh speed device define an access port (P1) at which an antenna is monolithically defined through its corresponding metallization features. Due to the limitation of the high-speed semiconductor substrate (105) dimensions (i.e. such as Indium Phosphide), these metallization do not have the required size for the antenna to cover the full frequency range, limited to operate above a cut-off frequency. However, being the antenna monolithically integrated on the high-speed semiconductor substrate (105), the interface between the ultrahigh speed device and the antenna is optimized to operate at the highest frequencies. As an example, FIG. 3A shows an edge illuminated photomixer device as the ultrahigh speed device, (i.e. waveguide accessed photodiode), illuminated through an optical fiber (130).

Furthermore, the ultra-wideband hybrid structure (100) comprises an optical waveguide (125) between the optical fiber (130) and the waveguide accessed photodiode when the optical fiber (130) provides edge optical illumination.

The substrate (110) is one which allows larger sizes (e.g. RF substrates such as quartz, laminates and ceramics) or Silicon among others), on which the larger metallization features corresponding to the TSA antenna or a bifilar metal waveguide can be established. The larger features of the antenna enable to operate over a frequency range that starts at the cut-off frequency of the antenna of the ultrahigh speed device in the high-speed semiconductor substrate (105) and extends towards lower frequencies.

The substrate (110) is located next to the high-speed semiconductor substrate (105), mating the metallization corresponding to the TSA antenna on each substrate, which are interconnected with an electrical interconnection (115) such as e.g. bonding or conductive epoxy. The electrical interconnection (115) avoids an impact on the performance of the structure (100) at high frequencies, obtaining an effective connection with low insertion losses. Hence, both reflections and excitation of surface waves are mitigated.

The structure (100) also comprises a dielectric waveguide structure (DRW) comprising a second access port (P2) and providing a high-pass characteristic interconnection operating over a high frequency range starting from a low cut-off frequency f_{CL} in the microwave range or in the millimeter-wave range. The structure (DRW) is established on the substrate (110) and on the high-speed semiconductor substrate (105), the structure (DRW) comprises a tapered end facing or connected to the access port (P1) of the ultrahigh speed device.

The structure (100) also comprises a bifilar metal waveguide structure (TSA) providing a low-pass characteristic interconnection, operating over a low frequency range from DC up to a high cut-off frequency f_{CH} in the millimeter wave range the structure (TSA) established on the substrate (110) and on the high-speed semiconductor substrate (105). The bifilar metal waveguide structure (TSA) is a tapered structure, i.e. it comprises a metal waveguide pattern defining a tapered coupler, preferably a Tapered Slot Antenna “TSA” around the tapered end of the dielectric waveguide structure (DRW) and located in the near field of the access port (P1) of the ultrahigh speed device.

The tapered bifilar metal waveguide structure (TSA) is established between the high-speed semiconductor substrate (105) and the substrate (110), where the larger features of the tapered bifilar metal waveguide are fabricated. By splitting the tapered bifilar metal waveguide structure (TSA) between both the substrate (110) and the high-speed semiconductor substrate (105), the high frequencies are coupled to the dielectric waveguide (DRW) before reaching the electrical interconnection via the electrical interconnection (115) e.g. conductive epoxy between both the substrate (110) and the high-speed semiconductor substrate (105), thus avoiding reflections.

By proper selection of the splitting point between the substrate (110) and the high-speed semiconductor substrate (105), each containing complementary parts of the tapered bifilar metal waveguide structure (TSA), the electrical interconnection between the corresponding metallization of the tapered bifilar metal waveguide structure (TSA) on each substrate (105, 110) does not disturb the high frequencies already coupled to the dielectric waveguide structure (DRW).

The structure (100) also comprises a second dielectric structure (120), preferably a pyramidal type structure etched on the high-speed semiconductor substrate (105). In some examples, the pyramidal type structure is a horn structure that can be established on either one or both substrates (105, 110) and which mitigates surface waves.

Hence, FIGS. 3A to 3D show the interconnection of a ultrahigh speed device (electronic or optoelectronic) manufactured on a high-speed semiconductor substrate (105) to another substrate (110) that can comprise the same or different permittivity having an electrical interconnection (115) e.g. epoxy established between both substrates (105, 110). The different embodiments of the structure (100) comprise both horizontal (edge) (FIG. 3A and FIG. 3C) and vertical (FIG. 3B and FIG. 3D) illumination with an optical fiber (130).

In order to mitigate surface modes on the ultrahigh speed device substrate, a second dielectric structure (120), preferably a pyramidal type structure may be etched on the high-speed semiconductor substrate (105) (FIG. 3C and FIG. 3D). This increases the amount of signal coupled in the fundamental mode of the dielectric waveguide (DRW), which makes it possible to bridge the discontinuity produced by the bonding of substrates with few reflections.

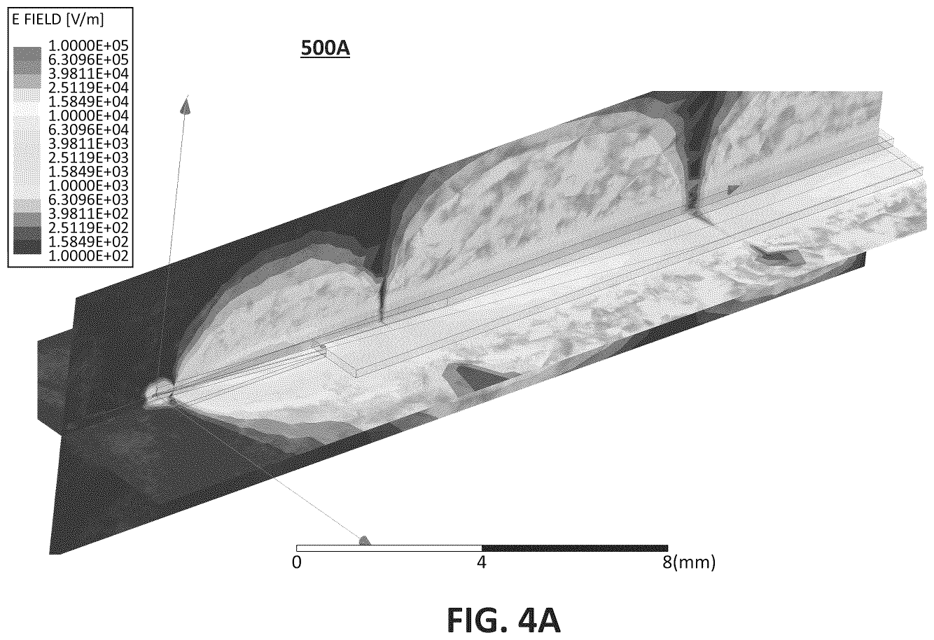

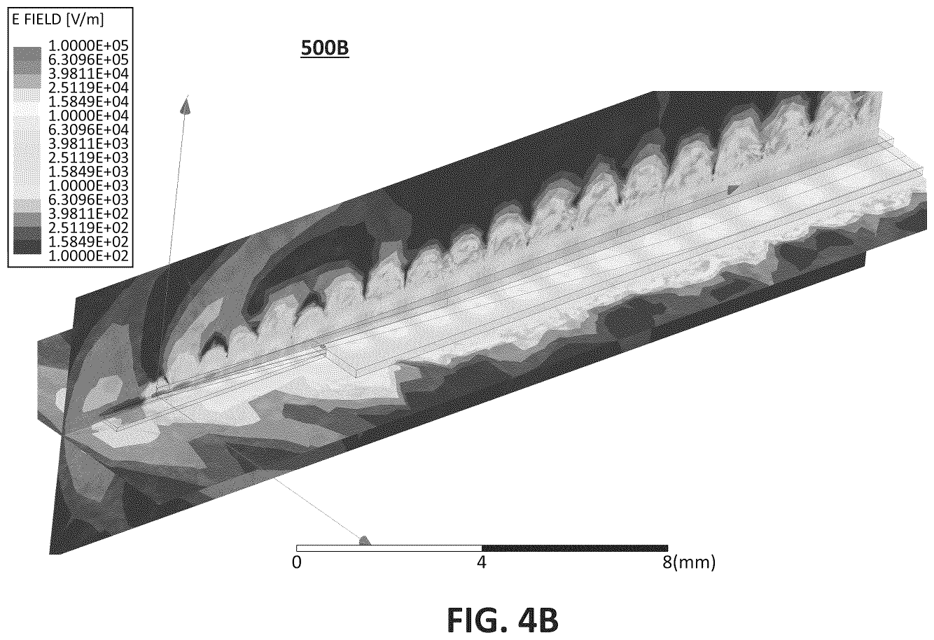

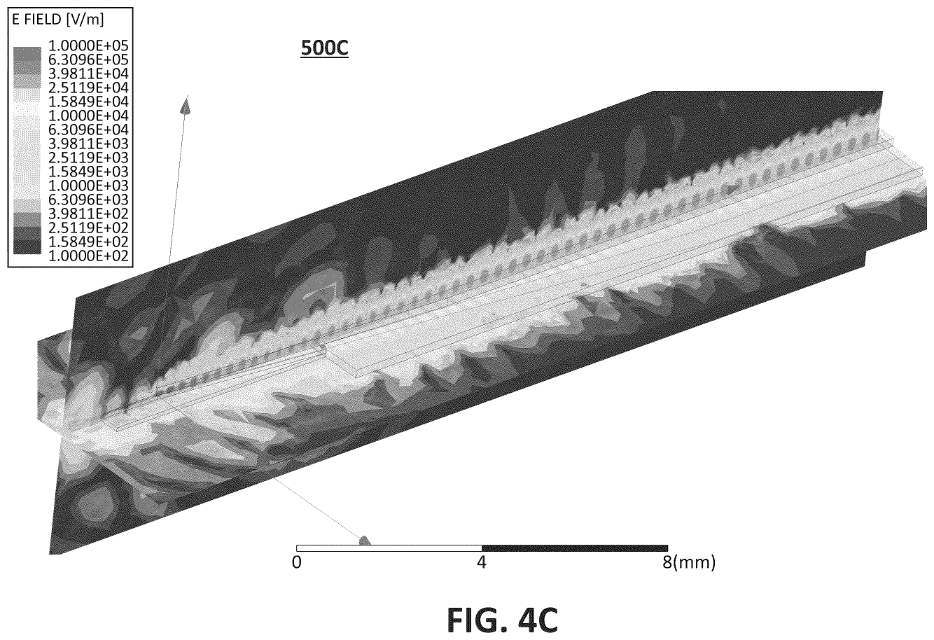

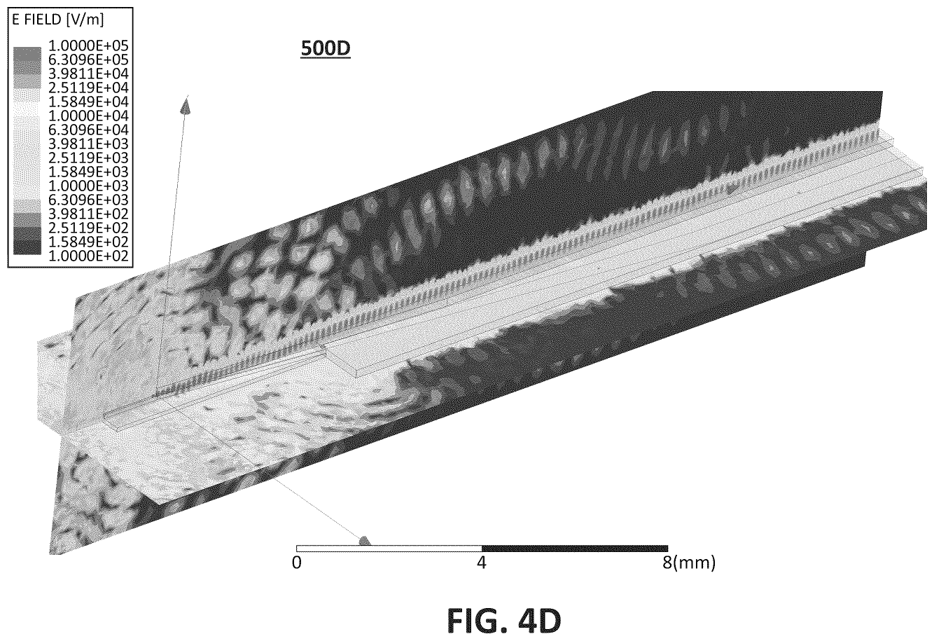

FIGS. 4A to 4D show the simulated electric field amplitude distribution at 10 GHz in FIG. 4A, 60 GHz in FIG. 4Bb, 140 GHz in FIG. 4C and 300 GHz in FIG. 4D for a horizontally illuminated photodiode (FIGS. 4A, 4C and 4E) made of substrate InP connected to an alumina substrate (Al2O3, ϵr=9.8) (logarithmic amplitude scale). In the simulations, it is shown how most of the signal travels between access ports (P1) and (P2) in a single mode at each frequency. As can be seen, at higher frequencies (figures B, C, and D) the signal is coupled from the antenna (TSA) (acting as a near field coupler) to the silicon (DRW) tapered end. This coupling occurs close to the photodiode, away from the discontinuity of substrates (105, 110), thus reducing signal reflections.

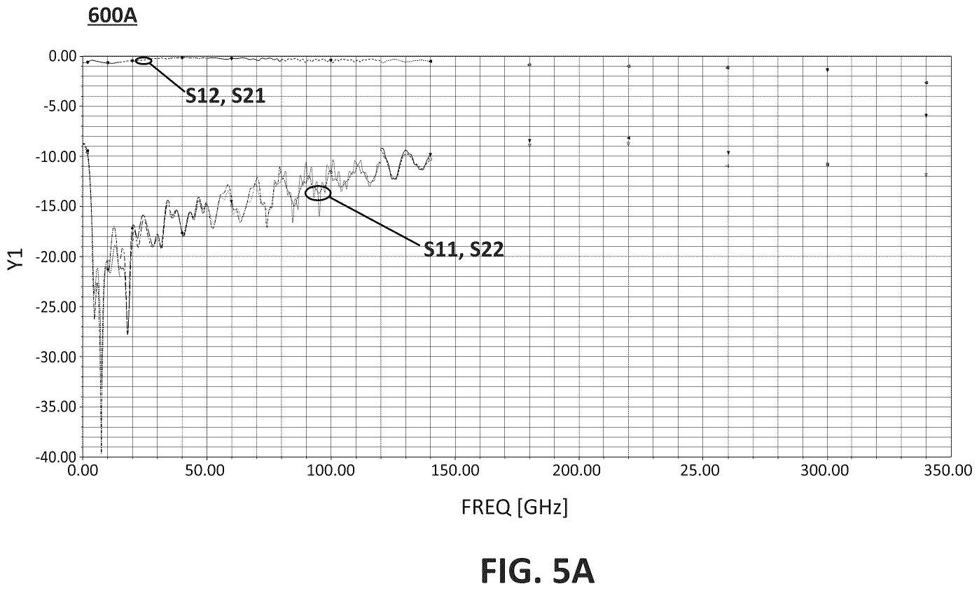

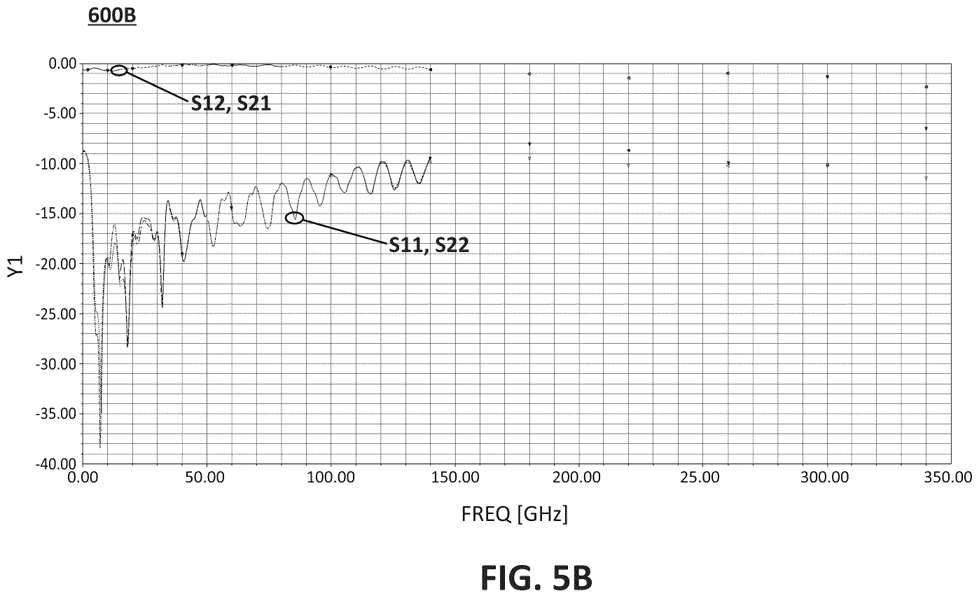

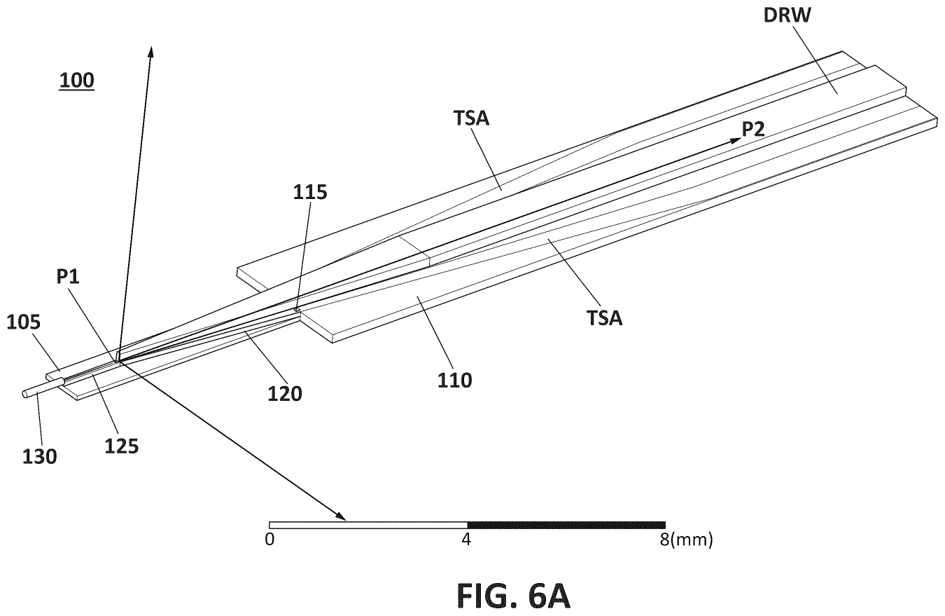

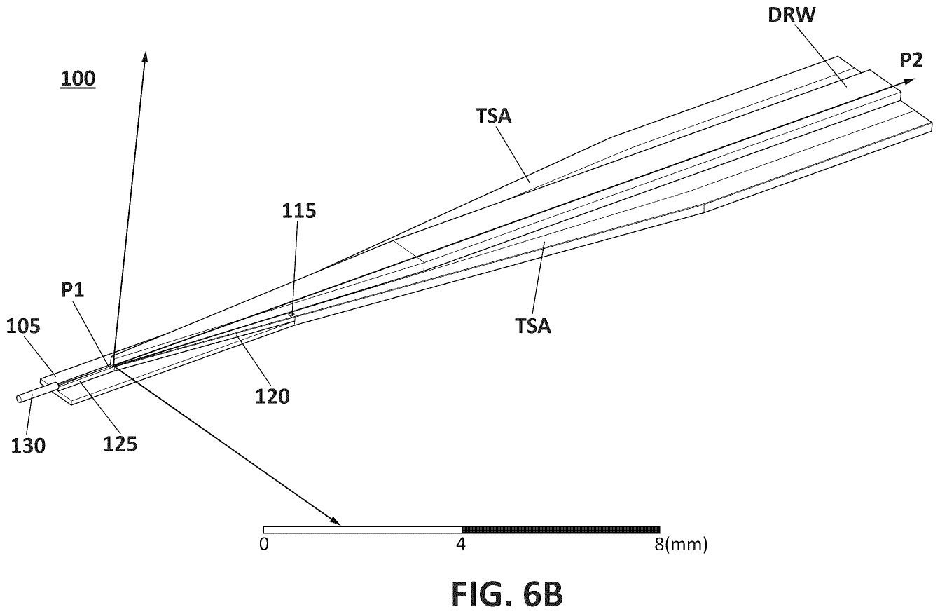

FIGS. 5A and 5B shows the S parameters obtained from the performed simulations shown in FIGS. 4A to 4D. Due to the discontinuity produced by the transition between substrates (105, 110) reflections may occur as shown in FIG. 5A, although the transmission of signals are possible (assuming a level of −3 dB in the S12 and S21) up to, at least, 340 GHz. In order mitigate these reflections, the edge of the high-speed semiconductor substrate (105) to which the ultrahigh speed device is connected can be wrapped on the (TSA) (FIG. 6b). As can be seen in the S parameters as shown in FIG. 5b, the reflections are suppressed, which reduces the level of ripple in the S parameters.

FIG. 6A shows another example of an ultra-wideband hybrid structure (100) for high-frequency electrical signals, that comprises the interconnection of an ultrahigh speed device for the generation or detection of high frequency signals on a high-speed semiconductor substrate (105) comprising high permittivity (for example, but not limited to, Indium Phosphide “InP”) and a substrate (110), as well as an electrical interconnection (115) between them.

In this particular example, the substrate (110) comprises a rectangular shape which is easier to cut. The substrate (110) is one which allows larger sizes (i.e. RF substrates such as quartz, laminates and ceramics) or Silicon among others), on which the larger metallization features corresponding to the TSA antenna or a bifilar metal waveguide can be established.

Furthermore, FIG. 6A also shows the ultrahigh speed device that comprises an edge illuminated photomixer device (i.e. waveguide accessed photodiode), illuminated through an optical fiber (130).

Due to the discontinuity produced by the transition between substrates (105, 110) reflections may occur as shown in FIG. 5A. In order mitigate these reflections, the edge of the substrate (110) can be wrapped on the (TSA). In this respect, FIG. 6B shows the interconnection of an ultrahigh speed device manufactured or established on a high permittivity substrate to another substrate (110) having a shape fitted or tapered to the metallic pattern (TSA). FIG. 6B also shows the ultrahigh speed device that comprises an edge illuminated photomixer device (i.e. waveguide accessed photodiode), illuminated through an optical fiber (130) and the second dielectric structure (120), preferably a pyramidal type structure etched on the high-speed semiconductor substrate (105).

1. An ultra-wideband hybrid structure for transmitting or receiving high-frequency electrical signals, the structure comprising:
a substrate;
a high-speed semiconductor substrate connected to the substrate;
an electrical interconnection established between the substrate and the high-speed semiconductor substrate;
an ultrahigh speed device for the generation or detection of high frequency signals comprising a first access port (P1) and established on the high-speed semiconductor substrate;
a dielectric waveguide structure comprising a second access port providing a high-pass characteristic interconnection operating over a high frequency range starting from a low cut-off frequency f_{CL} in the microwave range or in the millimeter-wave range, the structure established on the substrate and on the high-speed semiconductor substrate, wherein the structure comprises a tapered end facing the first access port of the ultrahigh speed device;
a metal waveguide structure providing a low-pass characteristic interconnection, operating over a low frequency range from DC up to a high cut-off frequency f_{CH} in the millimeter wave range, the structure established on the substrate and on the high-speed semiconductor substrate, wherein the metal waveguide structure comprises a metal waveguide pattern defining a tapered coupler, preferably a Tapered Slot Antenna “TSA”, around the tapered end of the dielectric waveguide structure and connected to the first access port of the ultrahigh speed device.

2. The ultra-wideband hybrid structure according to claim 1, wherein the substrate has a rectangular shape.

3. The ultra-wideband hybrid structure according to claim 1, wherein the substrate has a shape tapered to the metal waveguide structure.

4. The ultra-wideband hybrid structure for high-frequency electrical signals according to any of the preceding claims, further comprising a tapered structure, etched on the high-speed semiconductor substrate and/or the substrate.

5. The ultra-wideband hybrid structure for high-frequency electrical signals according to claim 4, wherein the tapered structure is a horn structure.

6. The ultra-wideband hybrid structure for high-frequency electrical signals according to claim 1, wherein the ultrahigh speed device is an optoelectronic device.

7. The ultra-wideband hybrid structure for high-frequency electrical signals according to claim 6, further comprising
an optical fiber providing edge optical illumination or vertical optical illumination to the high-speed photodiode.

8. The ultra-wideband hybrid structure for high-frequency electrical signals according to claim 6, wherein the optoelectronic device is a high-speed photodiode or a photoconductive antenna.

9. The ultra-wideband hybrid structure for high-frequency electrical signals according to claim 8, further comprising:
an optical waveguide between the optical fiber and the high-speed photodiode or the photoconductive antenna when the optical fiber provides edge optical illumination.

10. The ultra-wideband hybrid structure for high-frequency electrical signals according to claim 1, wherein the ultrahigh speed device is an electronic device.

11. The ultra-wideband hybrid structure for high-frequency electrical signals according to claim 1, wherein the high-speed semiconductor substrate comprises III-V compound semiconductors, such as Indium Phosphide, Gallium Nitride, Gallium Arsenide, InAlAs/InGaAs or AlGaN/GaN.

12. The ultra-wideband hybrid structure for high-frequency electrical signals according to claim 1, wherein the electrical interconnection comprises wire bonding, ribbon bonding, flip-chip bonding, or epoxy.

13. The ultra-wideband hybrid structure for high-frequency electrical signals according to claim 1, wherein the substrate comprises RF substrates such as quartz, laminates and ceramics or Silicon.
